(19) United States
(12) Patent Application Publication
(10) Pub. No.: US 2025/0249610 A1
(43) Pub. Date: Aug. 7, 2025

(54) Anti-loosening Structure and Folding Knife and Scissors Applying Same

(71) Applicant: GUANGXI RUIKE OUTDOOR TOOLS MANUFACTURING CO., LTD., Yulin (CN)

(72) Inventors: Gang Liang, Yulin (CN); Xiaoxuan Liang, Yulin (CN)

(21) Appl. No.: 18/907,633

(22) Filed: Oct. 7, 2024

(30) Foreign Application Priority Data
Feb. 3, 2024 (CN) 202420263136.0

(51) Int. Cl. B26B 5/00; B26B 13/04; B26B 13/20; B26B 13/28

(52) U.S. Cl. CPC B26B 5/00; B26B 13/04; B26B 13/20; B26B 13/28

(57) ABSTRACT

The present application discloses an anti-loosening structure, a folding knife and scissors applying same, wherein the anti-loosening structure includes a rotating shaft, a locking screw and a locking element. The rotating shaft is D-shaped, and the locking element is arranged on the rotating shaft which is static relative to the rotating shaft. The locking screw is arranged inside the rotating shaft and is threadedly connected with the rotating shaft or the locking element. The rotating shaft has a first end and a second end, wherein a limiting part is arranged on the first end of the rotating shaft, and the locking element is set on the outer side of the second end of the rotating shaft and is threadedly connected with the second end.

### CROSS-REFERENCE TO RELATED APPLICATIONS

The present application claims the benefit of Chinese Patent Application No. 202420263136.0 filed on Feb. 3, 2024, the contents of which are hereby incorporated by reference.

### TECHNICAL FIELD

The present application relates to a technical field of a structure preventing the rotating shaft from loosening, in particular to an anti-loosening structure and a folding knife and scissors applying same.

### BACKGROUND

For rotary tools such as scissors and folding knives, a blade of the scissors or the folding knife is usually connected with a screw through a rotating shaft (knife shaft) for convenient disassembling and debugging. To satisfy the rotating requirements of the rotary tools, screws should not be tightened too tightly when being assembled. To prevent the rotating shaft from loosening, the rotating shaft is usually D-shaped in the aforementioned structure, and a D-shaped hole adapted to the knife shaft is generally arranged on a knife handle and/or a blade, wherein the D-shaped hole is in clearance fit with the D-shaped shaft. To avoid the looseness of the screw, those skilled in the art often apply the threadlocker to the screw surface. However, after repeated use for a long time, the threadlocker on the screw is worn out and loses its anti-loosening ability, which contributes to the looseness of the screw, and then the looseness of the rotating shaft. Therefore, improvements are required.

### SUMMARY

In order to overcome at least one defect of the above-mentioned prior art, the present application provides an anti-loosening structure and a folding knife and scissors applying same, wherein the anti-loosening structure takes the advantages of simple structure, realizing hinged fastening of two objects as a rotating shaft, and avoiding looseness of the rotating shaft and the locking screw.

To achieve the above purposes, the technical solution adopted by the present application is to provide an anti-loosening structure, including a rotating shaft, a locking screw and a locking element. The rotating shaft is D-shaped, and the locking element is arranged on the rotating shaft which is static relative to the rotating shaft. The locking screw is arranged inside the rotating shaft and is threadedly connected with the rotating shaft or the locking element.

Optionally, the rotating shaft has a first end and a second end, wherein a limiting part is arranged on the first end of the rotating shaft, and the locking element is set on the outer side of the second end of the rotating shaft and is threadedly connected with the second end of the rotating shaft. One end of the locking screw is arranged on the inner side of the second end of the rotating shaft and the locking screw is threadedly connected with the rotating shaft.

Optionally, a stop member is arranged on the outer side of the locking element, which cooperates with the locking element to prevent the rotating shaft from driving the locking element to rotate.

Optionally, external threads of the second end of the rotating shaft are opposite to the thread rotating direction of internal threads of the rotating shaft, or the thread spacing of the external threads of the second end of the rotating shaft is unequal to the thread spacing of the inner threads of the rotating shaft.

Optionally, the locking element includes a threaded pipe part and a limiting plate part, wherein the threaded pipe part is inserted into the rotating shaft through the second end of the rotating shaft and its lateral wall is threadedly connected with the rotating shaft. The locking screw is sequentially inserted into the rotating shaft and the threaded pipe part through the limiting part of the first end of the rotating shaft. The threaded pipe part's medial wall is threadedly connected with the locking screw, and the limiting plate part is integrally arranged on one end of the threaded pipe part.

Optionally, external threads of the threaded pipe part are opposite to the thread rotating direction of internal threads of the threaded pipe part, or the thread spacing of the external threads of the threaded pipe part is unequal to the thread spacing of the inner threads of the threaded pipe part.

A folding knife, includes two knife handles and a blade, wherein the two knife handles are provided with shaft holes relative to each other and the shaft holes are D-shaped. The folding knife further includes the anti-loosening structure, the rotating shaft of the anti-loosening structure passes through the two shaft holes sequentially. The locking screw of the anti-loosening structure is threadedly connected with the second end of the rotating shaft after passing through one of the knife handles, which is used to limit the rotating shaft on the knife handle. The blade is rotatively assembled between the two knife handles through the rotating shaft. An accommodation slot is arranged on one side of the shaft hole in the knife handle, and the locking element and the stop member of the anti-loosening structure are both located in the accommodation slot, wherein the stop member abuts against the locking element.

Optionally, at least two convex teeth are arranged on the locking element's lateral wall and a recess is arranged between the two adjacent convex teeth. The stop member is an anti-loosening soft ring set outside the locking element, and the anti-loosening soft ring abuts against the accommodation slot's medial wall and the locking element's lateral wall.

Optionally, at least two convex teeth are arranged on the locking element's lateral wall and a recess is arranged between the two adjacent convex teeth. The stop member is a limiting protrusion arranged integrally on the accommodation slot's medial wall, wherein at least one limiting protrusion is arranged and is inserted into the recess.

Optionally, at least two convex teeth are arranged on the locking element's lateral wall and a recess is arranged between the two adjacent convex teeth. The stop member is a limiting screw fixed on the knife handle, and the limiting screw is located in the accommodation slot. The limiting screw's head part abuts against the recess and the limiting screw's head part is cone-shaped.

Optionally, at least two convex teeth are arranged on the locking element's lateral wall and a recess is arranged between the two adjacent convex teeth. The stop member comprises at least two soft columns arranged in the accommodation slot. The locking element is surrounded by the soft columns, and the soft columns are extruded into the recess.

Optionally, each knife handle includes a knife handle body and a lining arranged sequentially from outside to inside. The lining is embedded in one side of the knife handle body, and the locking element and the stop member are both located between one of the knife handle bodies and the lining of the knife handle.

A pair of scissors, includes a first blade body and a second blade body, wherein a D-shaped hole is arranged on the first blade body, and a rotating hole corresponding to the D-shaped hole is arranged on the second blade body. The scissors further includes an anti-loosening structure. The rotating shaft of the anti-loosening structure passes through the D-shaped hole and the rotating hole sequentially, and the rotating shaft is adapted to the D-shaped hole. The second blade body rotates around the rotating shaft, and the limiting part is limited on the outer side of the first blade body.

Optionally, a first counter bore is arranged on the limiting part, and the locking screw's head is limited in the first counter bore.

Optionally, a washer is respectively provided on the outer side of the first blade body and the second blade body, and a second counter bore is provided on the outer side of the washer. The anti-loosening structure passes through one washer, the D-shaped hole, the rotating hole and the other washer sequentially. The limiting part of the rotating shaft is limited in the second counter bore of one washer, and the limiting plate part of the locking element is limited in the second counter bore of another washer.

After adopting the above technical solutions, the beneficial effects of the present application are as follows: an anti-loosening structure, includes a rotating shaft, a locking screw and a locking element. The rotating shaft is D-shaped, and the locking element is arranged on the rotating shaft which is static relative to the rotating shaft. The locking screw is arranged inside the rotating shaft and is threadedly connected with the rotating shaft or the locking element. The anti-loosening structure provided by the present application is of simple structure, realizes hinged fastening of two objects as a rotating shaft, and avoids looseness of the rotating shaft and the locking screw.

A folding knife includes a blade and a knife handle, wherein the blade is hinged on the knife handle through the anti-loosening structure. The folding knife is of beautiful appearance, and the blade and the knife handle can be easily assembled and disassembled. In addition, even if the folding knife is used for a long time, the rotating shaft and the locking screw of the anti-loosening structure are not subject to looseness.

A pair of scissors includes two blade bodies overlapping each other, wherein the two blade bodies comprise a first blade body and a second blade body. The first blade body is hinged with the second blade body through the anti-loosening structure. Even if the scissors are used for a long time, the rotating shaft and the locking screw of the anti-loosening structure are not subject to looseness.

### BRIEF DESCRIPTION OF DRAWINGS

To better illustrate the technical solutions of the embodiments of the present application or the technical solutions of the prior art, a brief introduction of the figures that need to be used in the embodiments or the description of the prior art will be given below. Obviously, the figures in the following description are only some embodiments of the present application, for those of ordinary skill in the art, other figures can also be obtained based on these figures without inventive efforts.

FIG. 1 is an exploded schematic diagram of the anti-loosening structure in Embodiment 1;

FIG. 2 is a cross-sectional view of the anti-loosening structure in Embodiment 1;

FIG. 3 is another exploded schematic diagram of the anti-loosening structure in Embodiment 1;

FIG. 4 is another cross-sectional view of the anti-loosening structure in Embodiment 1;

FIG. 5 is a perspective view of the folding knife in Embodiment 2;

FIG. 6 is an exploded schematic diagram of the folding knife in Embodiment 2;

FIG. 7 is a cross-sectional view of the folding knife in Embodiment 2;

FIG. 8 is a perspective view of the folding knife in Embodiment 3;

FIG. 9 is an exploded schematic diagram of the folding knife in Embodiment 3;

FIG. 10 is another exploded schematic diagram of the folding knife in Embodiment 3;

FIG. 11 is an exploded schematic diagram of the folding knife in Embodiment 4;

FIG. 12 is an exploded schematic diagram of the folding knife in Embodiment 5;

FIG. 13 is another exploded schematic diagram of the folding knife in Embodiment 5;

FIG. 14 is a perspective view of the scissors in Embodiment 6;

FIG. 15 is an exploded schematic diagram of the scissors in Embodiment 6; and

FIG. 16 is a cross-sectional view of the scissors in Embodiment 6.

### NOTE OF THE REFERENCE SIGNS

knife handle; 11—knife handle body; 12—lining; 13—shaft hole; 14—accommodation slot; 2—blade; 3—rotating shaft; 30—anti—loosening structure; 31—limiting part; 32—first end; 33—second end; 4—locking screw; 5—locking element; 51—convex teeth; 52—threaded pipe part; 53—limiting plate part; 54—recess; 6—stop member; 61—limiting protrusion; 62—limiting screw; 63—soft column; 64—anti—loosening soft ring; 7—fixing screw; 8—shim; 91—first blade body; 911—D-shaped hole; 92—second blade body; 921—rotating hole; 93—washer; 94—bottle opening bayonet; 95—hanging hole; 96—serrated teeth.

### DESCRIPTION OF EMBODIMENTS

Below is a further detailed description of the present application in combination with the figures.

It should be noted that when an element is called as being “fixed to” or “arranged on” another element, it can be directly on another element or indirectly on another element. When an element is called as being “connected to” another element, it can be directly connected to another element or indirectly connected to another element.

It should be understood that the terms “length”, “width”, “upper”, “lower”, “front”, “rear”, “left”, “right”, “vertical”, “horizontal”, “top”, “bottom”, “inside” and “outside” which indicates the orientations or positional relationships are based on the orientations or positional relationships shown in the figures. They are only for facilitating describing the present application and simplifying the description, rather than indicating or implying that the device or element must have a specific orientation, construct and operate in a specific orientation. Therefore, it cannot be understood as a limitation of the present application.

In addition, the terms “first” and “second” are used for descriptive purposes only and cannot be understood as indicating or implying relative importance or implicitly indicating the quantity of indicated technical features. Therefore, a feature defined with “first” and “second” may explicitly or implicitly include one or more of these features. In the description of the present application, “a plurality of” means two or more, unless otherwise specifically defined.

### Embodiment 1

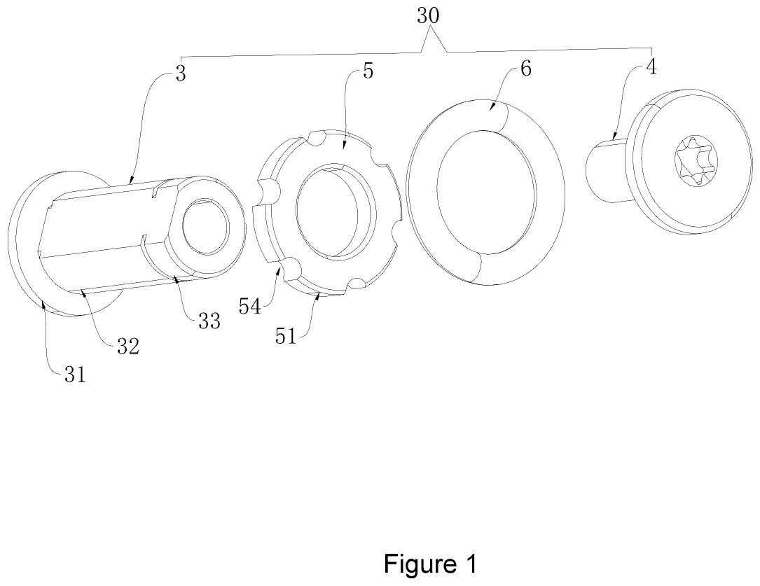

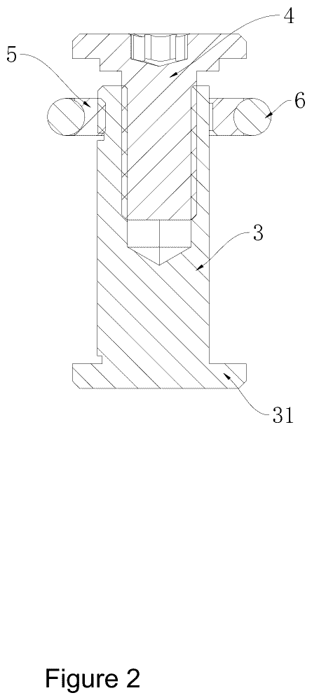

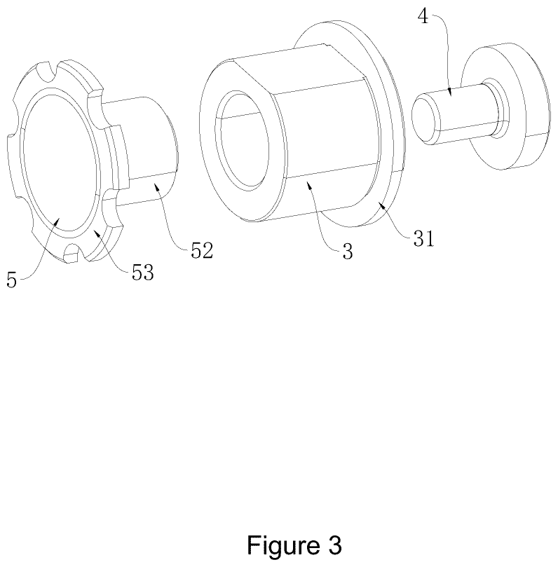

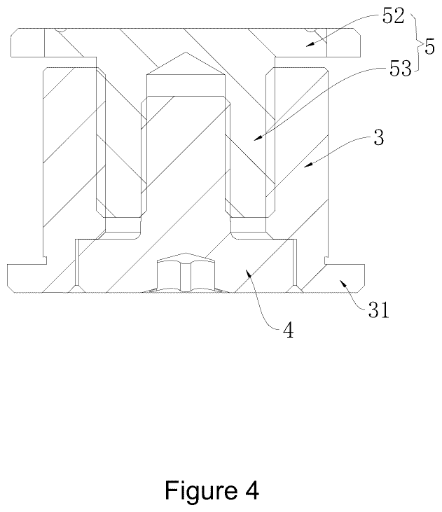

This embodiment relates to an anti-loosening structure, as shown in FIGS. 1 to 4, including a rotating shaft 3, a locking screw 4 and a locking element 5. The rotating shaft 3 is D-shaped and the locking element 5 is arranged on the rotating shaft 3 which is static relative to the rotating shaft 3. The locking screw 4 is arranged inside the rotating shaft 3 and is threadedly connected with the rotating shaft 3 or the locking element 5.

In some embodiments, the rotating shaft 3 has a first end 32 and a second end 33, wherein a limiting part 31 is arranged on the first end 32 of the rotating shaft 3, and the locking element 5 is set on the outer side of the second end 33 of the rotating shaft 3 and is threadedly connected with the second end 33. One end of the locking screw 4 is arranged on the inner side of the second end 33 of the rotating shaft 3 and is threadedly connected with the rotating shaft 3. In this embodiment, the locking element 5 is a nut.

Preferably, a stop member 6 is arranged on the outer side of the locking element 5, which cooperates with the locking element 5 to prevent the rotating shaft 3 from driving the locking element 5 to rotate. In this embodiment, the external threads of the second end 33 of the rotating shaft 3 are opposite to the thread rotating direction of the internal threads of the rotating shaft 3, or the thread spacing of the external threads of the second end 33 of the rotating shaft 3 is unequal to the thread spacing of the inner threads of the rotating shaft 3.

It should be illustrated that after the rotating shaft 3 passes through a first object and a second object sequentially, the locking element 5 is screwed on the outer side of the second end 33 of the rotating shaft 3. The locking element 5 cooperates with the limiting part 31 of the first end 32 of the rotating shaft 3 to limit the first object and the second object on the rotating shaft 3, which enables the first object and the second object to rotate around the rotating shaft 3, and prevents the rotating shaft 3 from detaching from the first object and the second object. Then the locking screw 4 is screwed and fixed on the rotating shaft 3. In some embodiments, because the thread spacing between the external threads and the inner threads of the rotating shaft 3 is different, the locking element 5 and the locking screw 4 do not simultaneously rotate or loosen, which realizes prevention of the rotating shaft 3 from detaching from the first object and/or the second object. In some embodiments, when the locking screw 4 is loose, it drives the rotating shaft 3 to rotate. However, in this embodiment, because the thread rotating direction of the external threads and the inner threads of the rotating shaft 3 is different, the rotating shaft 3 is rotated more and more tightly relative to the locking element 5 and thus prevents the rotating shaft 3 from loosening.

In some embodiments, the rotating shaft 3 has a first end 32 and a second end 33, wherein a limiting part 31 is arranged on the first end 32 of the rotating shaft 3. The locking element 5 includes a threaded pipe part 52 and a limiting plate part 53, wherein the threaded pipe part 52 is inserted into the rotating shaft 3 through the second end 33 and its lateral wall is threadedly connected with the rotating shaft 3. The locking screw 4 is sequentially inserted into the rotating shaft 3 and the threaded pipe part 52 through the limiting part 31 of the first end 32. The medial wall of the threaded pipe part 52 is threadedly connected with the locking screw 4, and the limiting plate part 53 is integrally arranged on one end of the threaded pipe part 52. Specifically, the external threads of the threaded pipe part 52 are opposite to the thread rotating direction of the internal threads of the threaded pipe part 52, or the thread spacing of the external threads of the threaded pipe part 52 is unequal to the thread spacing of the inner threads of the threaded pipe part 52.

It should be illustrated that after the rotating shaft 3 passes through a first object and a second object sequentially, the lateral wall of the threaded pipe part 52 of the locking element 5 is screwed and fixed with the medial wall of the second end 33 of the rotating shaft 3. The limiting plate part 53 of the locking element 5 cooperates with the limiting part 31 of the first end 32 of the rotating shaft 3 for limiting the first object and the second object on the rotating shaft 3, which enables the first object and the second object to rotate around the rotating shaft 3, and prevents the rotating shaft 3 from detaching from the first object and the second object. Then the locking screw 4 stretches into the rotating shaft 3 through the first end 32 of the rotating shaft 3. The locking screw 4 is configured to be screwed in the threaded pipe part 52 of the locking element 5. In some embodiments, because the thread spacing between the external threads and the inner threads of the threaded pipe part 52 is different, the locking element 5 and the locking screw 4 do not simultaneously rotate or loosen, which realizes prevention of the rotating shaft 3 from detaching from the first object and/or the second object. In some embodiments, when the locking screw 4 is loose, it drives the locking element 5 to rotate. However, in this embodiment, because the thread rotating direction of the external threads and the inner threads of the threaded pipe part 52 of the locking element 5 is different, the locking element 5 is rotated more and more tightly relative to the rotating shaft 3 and thus prevents the rotating shaft 3 from loosening.

Optionally, an anti-loosening plastic ring is set between the screw head of the locking screw 4 and the threaded pipe part 52. The anti-loosening plastic ring is set to increase the friction between the locking screw 4 and the threaded pipe part 52, so as to further prevent the rotating shaft 3 from loosening.

### Embodiment 2

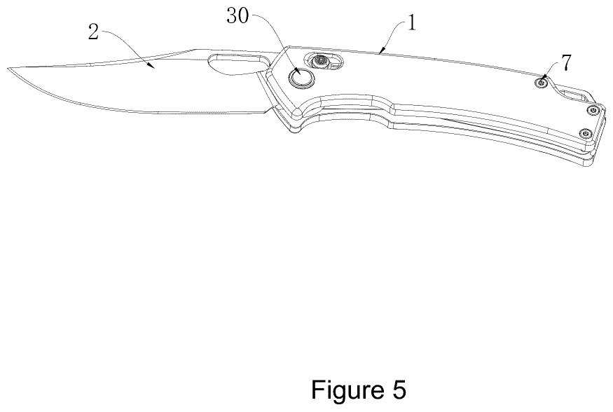

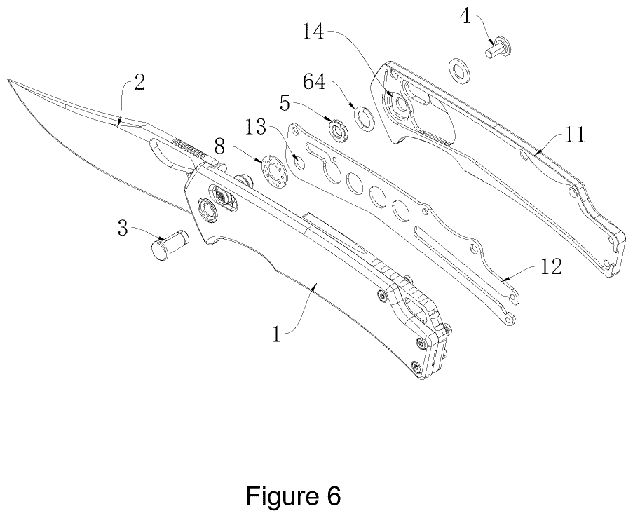

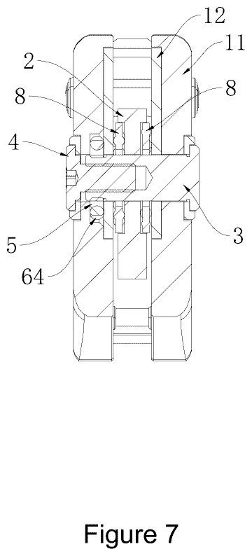

This embodiment is improved on the basis of the Embodiment 1. As shown in FIGS. 5 to 7, a folding knife includes two knife handles 1 and a blade 2, wherein the two knife handles 1 are provided with shaft holes 13 relative to each other and the shaft holes 13 are D-shaped. The folding knife further includes the anti-loosening structure 30, the rotating shaft 3 of the anti-loosening structure 30 passes through the two shaft holes 13 sequentially. The D-shaped shaft hole 13 on the knife handle 1 is in clearance fit with the rotating shaft 3. The locking screw 4 of the anti-loosening structure 30 is threadedly connected with the second end 33 of the rotating shaft 3 after passing through one of the knife handles 1, which is used to limit the rotating shaft 3 on the knife handle 1. The blade 2 is rotatively assembled between the two knife handles 1 through the rotating shaft 3. Fixing screws 7 are arranged on the end of the knife handle 1, which makes an accommodation slot 14 for holding the blade 2 be formed between the two knife handles 1. The accommodation slot 14 is arranged on one side of the shaft hole 13 in the knife handle 1, and the locking element 5 is threadedly fixed on the outer side of the second end 33 of the rotating shaft 3. The locking element 5 and the stop member 6 of the anti-loosening structure 30 are both located in the accommodation slot 14, wherein the stop member 6 abuts against the locking element 5. The stop member 6 is used to cooperate with the locking element 5 to prevent the rotating shaft 3 from driving the locking element 5 to rotate relative to the knife handle 1, so as to further prevent the rotating shaft 3 from detaching from the knife handle 1.

Optionally, at least two convex teeth 51 are arranged on the lateral wall of the locking element 5 and a recess 54 is arranged between the two adjacent convex teeth 51. The locking element may have a splined teeth shape but is not limited to a splined teeth shape. The stop member 6 is an anti-loosening soft ring 64 set outside the locking element 5, and the anti-loosening soft ring 64 abuts against the medial wall of the accommodation slot 14 and the lateral wall of the locking element 5. The anti-loosening soft ring 64 increases the friction between the knife handle 1 and the rotating shaft 3 to further prevent the rotating shaft 3 and/or the locking screw 4 from loosening. Preferably, in order for the anti-loosening soft ring 64 to be stably mounted in the accommodation slot 14, an annular clamping groove for clamping the anti-loosening soft ring 64 is arranged on the medial wall of the accommodation slot 14. The accommodation slot 14 and the annular clamping groove are both arranged on the knife handle 1.

Optionally, to make the folding knife more beautiful and avoid exposing the locking element 5 at the same time, each knife handle 1 includes a knife handle body 11 and a lining 12 arranged sequentially from outside to inside. The lining 12 is embedded in one side of the knife handle body 11, and the locking element 5 and the stop member 6 are both located between the knife handle body 11 and the lining 12 of the knife handle 1. Specifically, the accommodation slot 14 is located on the knife handle body 11 of the knife handle 1, and the shaft hole is located on the lining 12. The size of the locking element 5 is larger than the size of the shaft hole 13. For example, the two knife handles 1 are respectively a first knife handle and a second knife handle, wherein the accommodation slot 14 is located on the knife handle body 11 of the second knife handle. The rotating shaft 3 is arranged in the accommodation slot 14 after passing through the knife handle body 11 of the first knife handle, the lining 12 of the first knife handle, the blade 2 and the lining 12 of the second knife handle, while the limiting part 31 is currently limited on the outer side of the knife handle body 11 of the first knife handle. The locking screw 4 is threadedly connected with the rotating shaft 3 after passing through the knife handle body 11 of the second knife handle, and the screw head of the locking screw 4 is limited on the outer side of the knife handle body 11.

Furthermore, a placement slot for holding the lining 12 is arranged on one side of the knife handle body 11. The lining 12 is fixed by a screw in the placement slot of the knife handle body 11, and the accommodation slot 14 is arranged in the placement slot. A washer is respectively provided on the outer side of two knife handle bodies 11, and a second counter bore is provided on each washer. The second counter bores on the two knife handle bodies 11 are respectively used for holding the screw heads of the limiting part 31 and the locking screw 4.

Furthermore, a shim 8 is further set on the rotating shaft 3, which is located between the blade 2 and the lining 12 to make the structure of the folding knife more compact, prevent the rotating shaft 3 from moving left and right in the shaft hole 13, prevent the blade 2 from being directly contacted with the lining 12 at the same time, and reduce friction by reducing the contact area of the lateral wall of the blade 2, to make the opening and storage of the blade 2 more smooth.

### Embodiment 3

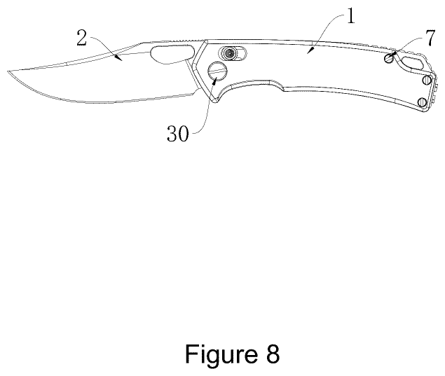

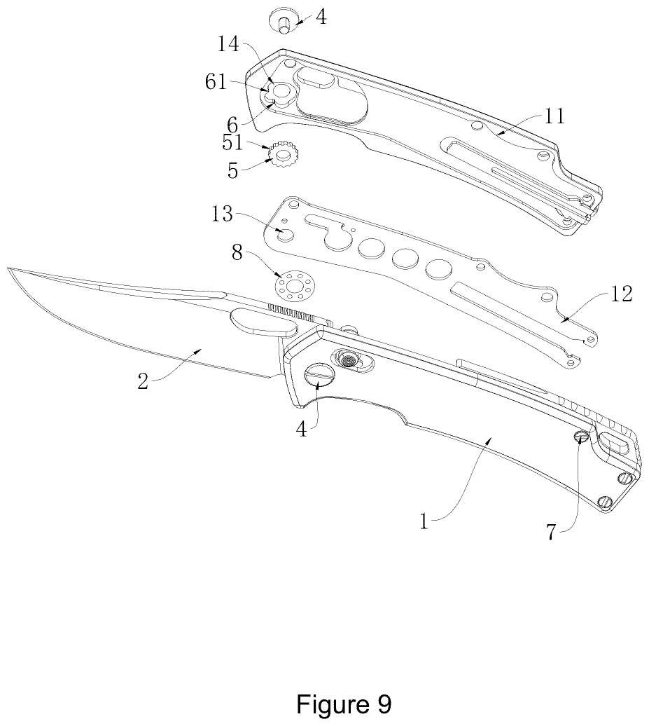

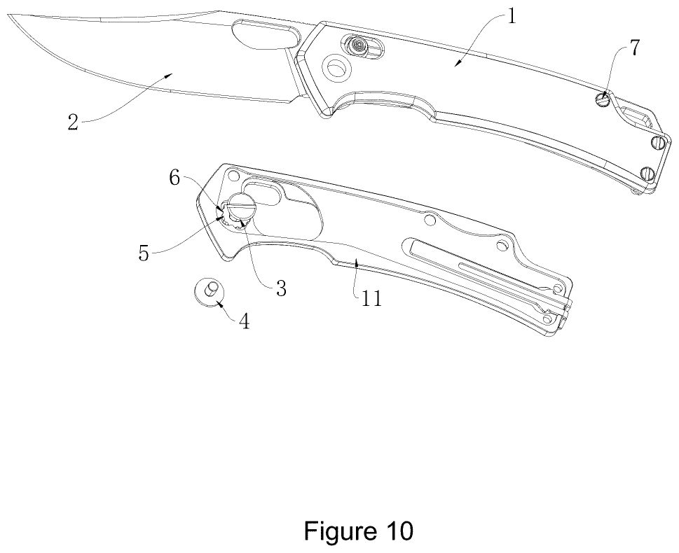

This embodiment is improved on the basis of the Embodiment 1 and differs from the Embodiment 2 mainly in that as shown in FIGS. 8 to 10, at least two convex teeth 51 are arranged on the lateral wall of the locking element 5 and a recess 54 is arranged between the two adjacent convex teeth 51. The stop member 6 is a limiting protrusion 61 arranged integrally on the medial wall of the accommodation slot 14, wherein at least one limiting protrusion 61 is arranged and is inserted into the recess 54. The limiting protrusion 61 is inserted into the recess 54 of the locking element 5 to further limit the looseness of the rotating shaft 3 and realize the prevention of the rotating shaft 3 and/or the locking screw 4 from loosening. In this embodiment, two limiting protrusions 61 are alternately set but not limited to two limiting protrusions 61.

### Embodiment 4

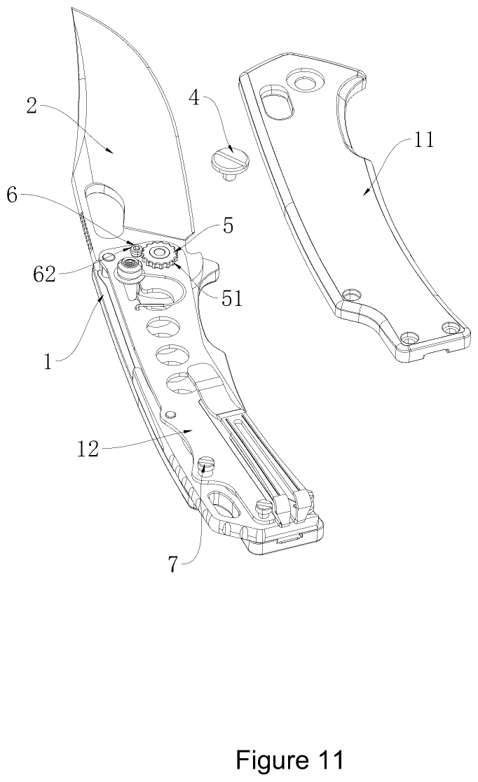

This embodiment is improved on the basis of the Embodiment 1 and differs from the Embodiment 2 and Embodiment 3 mainly in that as shown in FIG. 11, at least two convex teeth 51 are arranged on the lateral wall of the locking element 5 and a recess 54 is arranged between the two adjacent convex teeth 51. The stop member 6 is a limiting screw 62 fixed on the knife handle 1, and the limiting screw 62 is located in the accommodation slot 14. The screw head of the limiting screw 62 abuts against the recess 54 and the screw head of the limiting screw 62 is cone-shaped. The cone-shaped screw head of the limiting screw 62 abuts against the recess 54 of the locking element 5 to realize the purpose of preventing the rotating shaft 3 and/or the locking screw 4 from loosening.

### Embodiment 5

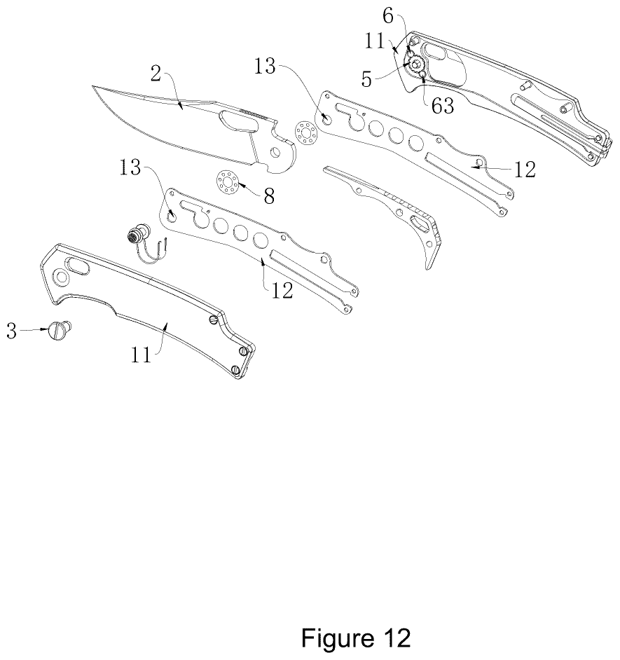

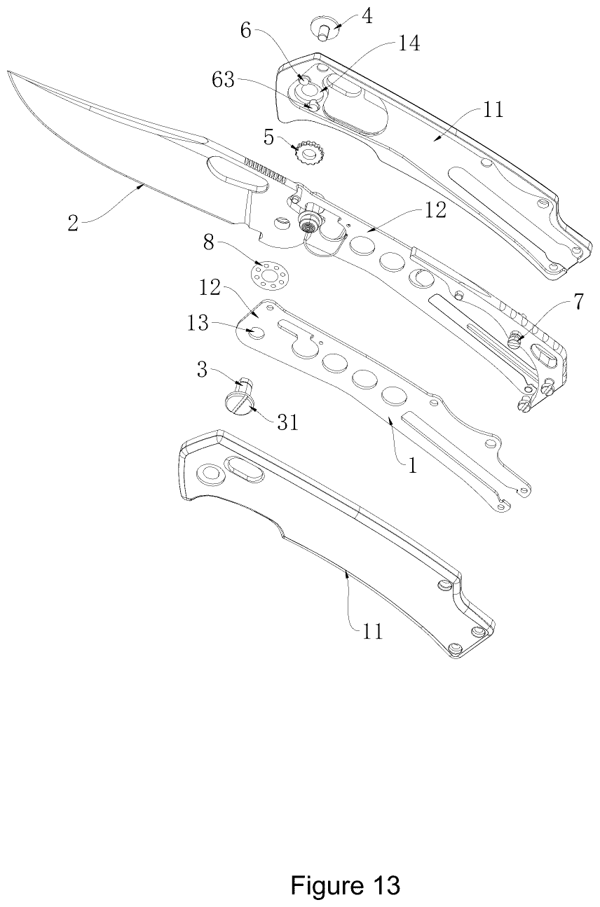

This embodiment is improved on the basis of the Embodiment 1 and differs from the Embodiments 2 to 4 mainly in that as shown in FIGS. 12 and 13, at least two convex teeth 51 are arranged on the lateral wall of the locking element 5 and a recess 54 is arranged between the two adjacent convex teeth 51. The stop member 6 is at least two soft columns 63 arranged in the accommodation slot 14. The locking element 5 is surrounded by the soft columns 63, and the soft columns 63 can be extruded into the recess 54. In this Embodiment, the two soft columns are arranged symmetrically and located respectively on both sides of the locking element 5. Both the soft columns 63 and the locking element 5 are located in the accommodation slot 14 of the knife handle body 11. The two ends of the soft columns 63 are respectively connected with the knife handle body 11 and the lining 12. The soft columns 63 and the locking element 5 extrude each other to produce friction to realize the purpose of preventing the rotating shaft 3 and/or the locking screw 4 from loosening.

### Embodiment 6

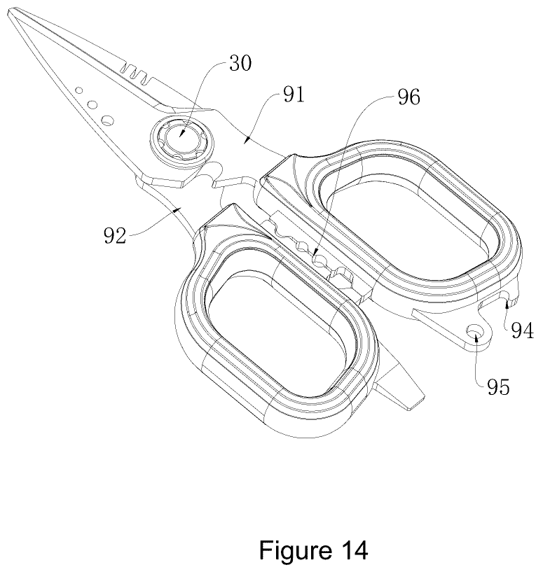

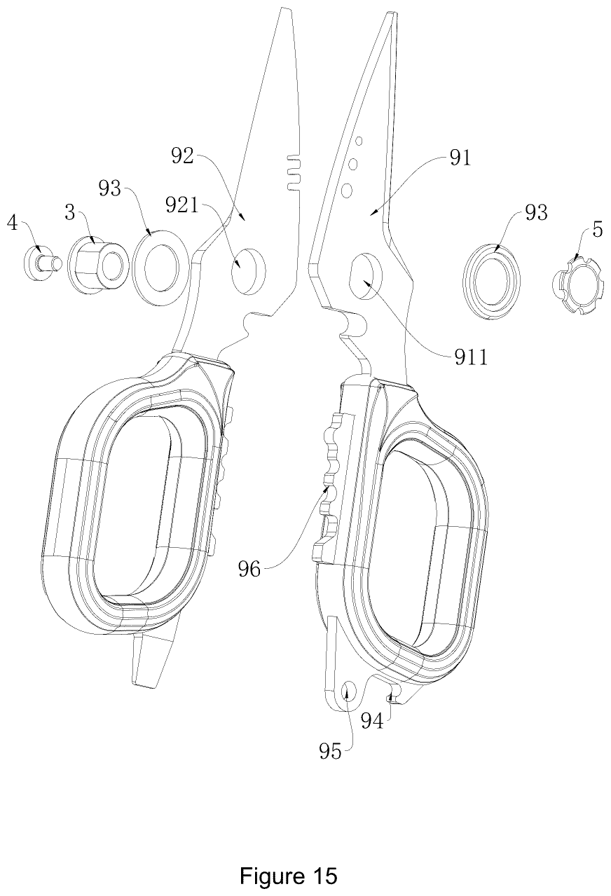

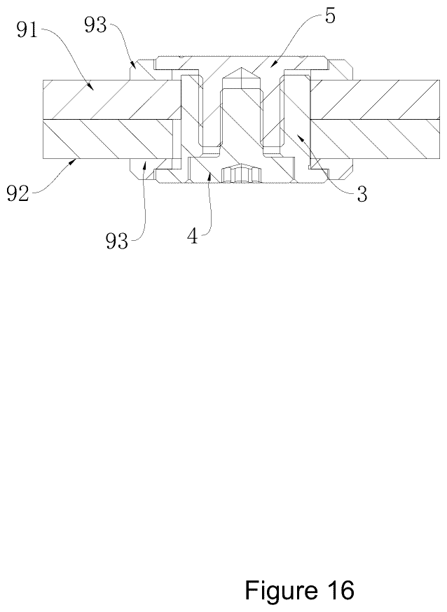

This embodiment is improved on the basis of the Embodiment 1 and differs from the Embodiments 2 to 5 mainly in that as shown in FIGS. 14 to 16, a pair of scissors, includes a first blade body 91 and a second blade body 92, wherein a D-shaped hole 911 is arranged on the first blade body 91, and a rotating hole 921 corresponding to the D-shaped hole 911 is arranged on the second blade body 92. The first blade body 91 is cross-stacked with the second blade body 92. The scissors further includes an anti-loosening structure 30. The rotating shaft 3 of the anti-loosening structure 30 passes through the D-shaped hole 911 and the rotating hole 921 sequentially. The adaption of the rotating shaft 3 to the D-shaped hole 911 makes the first blade body 91 static relative to the rotating shaft 3, and the second blade body 92 rotate around the rotating shaft 3. The limiting part 31 is limited on the outer side of the first blade body 91. Specifically, a first counter bore is arranged on the limiting part 31, and the screw head of the locking screw 4 is limited in the first counter bore.

Optionally, a washer 93 is respectively provided on the outer side of the first blade body 91 and the second blade body 92, and a second counter bore is respectively provided on the outer side of each washer 93. The anti-loosening structure 30 passes through one washer 93, the D-shaped hole 911, the rotating hole 921 and the other washer 93 sequentially. The limiting part 31 of the rotating shaft 3 is limited in the second counter bore of one washer 93, and the limiting plate part 53 of the locking element 5 is limited in the second counter bores of another washer 93. Several convex teeth 51 are alternately set on the lateral wall of the limiting plate part 53 of the locking element 5, and a recess 54 is arranged between the two convex teeth 51. The recess 54 is used to cooperate with external tools, such as a spanner, for a user's disassembling and assembling the scissors.

Specifically, the first blade body 91 includes a first cutter head structure of the blade and a first handle in sequence, while the second blade body 92 includes a second cutter head structure of the blade and a second handle. The D-shaped hole 911 is arranged on the end of the first cutter head structure and the rotating hole 921 is arranged on the end of the second cutter head structure. Serrated teeth 96 are arranged relatively on the first handle and the second handle, which enables the scissors to have the functions of a nut cracker. Optionally, a hanging hole 95 is provided on the end of the first handle or the second handle. Optionally, a bottle opening bayonet 94 is provided on the end of the first handle and/or the second handle.

When being assembled, the rotating shaft 3 passes through one washer 93, the D-shaped hole 911 of the first blade body 91 and the rotating hole 921 of the second blade body 92 sequentially, and is placed in the other washer 93. The limiting part 31 of the rotating shaft 3 is currently limited in the first counter bore of the washer 93, and the washer 93 is limited on the outer side of the first blade body 91. Then, the threaded pipe part 52 of the locking element 5 passes through the washer 93 and is threadedly fixed with the medial wall of the second end 33 of the rotating shaft 3. The limiting plate part 53 of the locking element 5 is now limited in the second counter bore of the washer 93, which is located on the outer side of the second blade body 92. Lastly, the locking screw 4 is threadedly fixed with the medial wall of the threaded pipe part 52 of the locking element 5 after passing through the rotating shaft 3, and the screw head of the locking screw 4 is limited in the first counter bore of the limiting part 31. By hinged fastening the two blade bodies with the anti-loosening structure 30, the looseness of the rotating shaft 3 is prevented even the scissors have been used several times for cutting.

The above description is only for illustration of the technical solutions of the present application, rather than limitation of the present application. Any modifications or equivalent substitutions of the present application made by the ordinary skilled persons in the art, within the spirit and principles of the present application, should be involved in the protection scope of the present application.

1. An anti-loosening structure, includes a rotating shaft, a locking screw and a locking element;
wherein the rotating shaft is D-shaped;
wherein the locking element is arranged on the rotating shaft, which is static relative to the rotating shaft;
wherein the locking screw is arranged in the rotating shaft and is threadedly connected with the rotating shaft or the locking element.

2. The anti-loosening structure according to claim 1, wherein the rotating shaft has a first end and a second end; a limiting part is arranged on the first end of the rotating shaft, and the locking element is set on an outer side of the second end of the rotating shaft and is threadedly connected with the second end of the rotating shaft; one end of the locking screw is arranged on an inner side of the second end of the rotating shaft and the locking screw is threadedly connected with the rotating shaft.

3. The anti-loosening structure according to claim 2, wherein a stop member is arranged on an outer side of the locking element, which cooperates with the locking element to prevent the rotating shaft from driving the locking element to rotate.

4. The anti-loosening structure according to claim 3, wherein external threads of the second end of the rotating shaft are opposite to the thread rotating direction of internal threads of the rotating shaft, or the thread spacing of the external threads of the second end of the rotating shaft is unequal to the thread spacing of the inner threads of the rotating shaft.

5. The anti-loosening structure according to claim 1, wherein the rotating shaft has a first end and a second end; a limiting part is arranged on the first end of the rotating shaft; the locking element includes a threaded pipe part and a limiting plate part, wherein,
the threaded pipe part is inserted into the rotating shaft through the second end and its lateral wall is threadedly connected with the rotating shaft;
the locking screw is sequentially inserted into the rotating shaft and the threaded pipe part through the limiting part of the first end, and the threaded pipe part's medial wall is threadedly connected with the locking screw;
the limiting plate part is integrally arranged on one end of the threaded pipe part.

6. The anti-loosening structure according to claim 5, wherein external threads of the threaded pipe part are opposite to the thread rotating direction of internal threads of the threaded pipe part, or the thread spacing of the external threads of the threaded pipe part is unequal to the thread spacing of the inner threads of the threaded pipe part.

7. A folding knife, includes two knife handles and a blade, wherein the two knife handles are provided with shaft holes relative to each other and the shaft holes are D-shaped, wherein the folding knife further includes the anti-loosening structure of claim 4; the rotating shaft of the anti-loosening structure passes through the two shaft holes sequentially; the locking screw of the anti-loosening structure is threadedly connected with the second end of the rotating shaft after passing through one of the knife handles, which is used to limit the rotating shaft on the knife handle; the blade is rotatively assembled between the two knife handles through the rotating shaft, and an accommodation slot is arranged on one side of the shaft hole in the knife handle; the locking element and the stop member of the anti-loosening structure are both located in the accommodation slot, and the stop member abuts against the locking element.

8. The folding knife according to claim 7, wherein at least two convex teeth are arranged on the locking element's lateral wall and a recess is arranged between two adjacent convex teeth; the stop member is an anti-loosening soft ring set outside the locking element, and the anti-loosening soft ring abuts against the accommodation slot's medial wall and the locking element's lateral wall.

9. The folding knife according to claim 7, wherein at least two convex teeth are arranged on the locking element's lateral wall and the recess is arranged between the two adjacent convex teeth; the stop member is a limiting protrusion arranged integrally on the accommodation slot's medial wall, wherein at least one limiting protrusion is arranged and is inserted into the recess.

10. The folding knife according to claim 7, wherein at least two convex teeth are arranged on the locking element's lateral wall and the recess is arranged between the two adjacent convex teeth; the stop member is a limiting screw fixed on the knife handle, and the limiting screw is located in the accommodation slot; the limiting screw's head part abuts against the recess and the limiting screw's head part is cone-shaped.

11. The folding knife according to claim 7, wherein at least two convex teeth are arranged on the locking element's lateral wall and the recess is arranged between the two adjacent convex teeth; the stop member comprises at least two soft columns that are arranged in the accommodation slot; the locking element is surrounded by the soft columns, and the soft columns are extruded into the recess.

12. The folding knife according to claim 7, wherein each knife handle comprises a knife handle body and a lining arranged sequentially from outside to inside; the lining is embedded in one side of the knife handle body, and the locking element and the stop member are both located between one of the knife handle bodies and the lining of the knife handle; the shaft holes are arranged on the lining.

13. A pair of scissors, comprises a first blade body and a second blade body, wherein a D-shaped hole is arranged on the first blade body, and a rotating hole corresponding to the D-shaped hole is arranged on the second blade body, wherein the scissors further comprises the anti-loosening structure of claim 6; the rotating shaft of the anti-loosening structure passes through the D-shaped hole and the rotating hole sequentially, and the rotating shaft is adapted to the D-shaped hole; the second blade body rotates around the rotating shaft, and the limiting part is limited on an outer side of the first blade body.

14. The scissors according to claim 13, wherein a first counter bore is arranged on the limiting part, and the locking screw's head is limited inside the first counter bore.

15. The scissors according to claim 13, wherein a washer is respectively provided on the outer side of the first blade body and the second blade body, and a second counter bore is provided on an outer side of each washer; the anti-loosening structure passes through one washer, the D-shaped hole, the rotating hole and the other washer sequentially; the limiting part of the rotating shaft is limited in the second counter bore of one washer, and the limiting plate part of the locking element is limited in the second counter bore of another washer.
